(19) United States
(12) Patent Application Publication
(10) Pub. No.: US 2015/0053018 A1
(43) Pub. Date: Feb. 26, 2015

(54) FILM ELASTICITY TESTING METHOD FOR COATED PARTS

(71) Applicant: Robert Bosch GmbH, Stuttgart (DE)

(72) Inventor: Takao Sugama, Commerce Township, MI (US)

(21) Appl. No.: 14/108,880

(22) Filed: Dec. 17, 2013

Related U.S. Application Data
(60) Provisional application No. 61/869,237, filed on Aug. 23, 2013.

(51) Int. Cl. G01N 3/20; G01N 3/06; G01N 27/04

(52) U.S. Cl. CPC G01N 3/20; G01N 27/041; G01N 3/066
USPC 73/849

(57) ABSTRACT

A test method for evaluating elasticity of a coating. A coating is applied onto a conductive substrate to form a test specimen. The test specimen is bent into a shape having a bend axis and a bend area having a radius of curvature that increases along the bend axis from a first end to a second end of the test specimen. Conductivity of the coating is measured at a plurality of different measurement points at different distances along the bend axis within the bend area. The measured conductivity values are correlated to the distances along the bend axis to determine an elongation limit of the coating.

### CROSS-REFERENCE TO RELATED APPLICATIONS

This application claims priority to U.S. Provisional Patent Application No. 61/869,237 filed Aug. 23, 2013, the entire contents of which are incorporated by reference herein.

### BACKGROUND

The present invention relates to testing methods for testing elasticity or cracking resistance of coating film. Presently known methods using thin film made from lab equipment are impractical. The precision and repeatability of ASTM D522 testing methods can be improved upon.

In manufacturing, a deformation process may be carried out among two components to physically couple the components together. For example, two shell or housing portions 12A, 12B of a brake booster 12 (FIGS. 19 and 20) may be joined by assembling the two portions 12A, 12B with an area of overlap 14 and then knurling in the area of overlap 14. Such a process is effective for establishing a coupling between the components, but can lead to accelerated corrosion by affecting the integrity of a surface coating applied to one of the portions 12A, 12B. For example, the coating film may exhibit micro-cracking that can impair the ability of the coating to shield the underlying substrate from the elements. Typical coating processes, such as electrodeposition or “e-coat” for example, or powdercoating, are subject to influence from a large number of co-dependent variables, including not only the coating application but also curing conditions, such that monitoring all variables and understanding the effects of all different combinations of these variables to guarantee a satisfactorily crack-resistant coating is difficult to achieve without a large amount of complicated instrumentation and data processing. Rather, it may be preferred to test coated parts to ensure that the finished coating complies with corrosion specifications. Such tests can include salt spray testing (SST) and/or cyclic corrosion testing (CCT), in which tested samples display varying levels of corrosion to be evaluated. However, the evaluation is largely subjective and not suited for proper numerical analysis. For example, specimens may be visually inspected and given a rating based on the amount or type of corrosion displayed (e.g., on a 1 to 5 scale). However, consistently differentiating between amounts or types of corrosion is difficult, even for a single individual, let alone a large number of different individuals examining test specimens. Thus, there is a need for a measurement-based testing method for evaluating the corrosion resistance of coated parts.

### SUMMARY

In one aspect, the invention provides a test method for evaluating elasticity of a coating. A coating is applied onto a conductive substrate to form a test specimen. The test specimen is bent into a shape having a bend axis and a bend area having a radius of curvature that increases along the bend axis from a first end to a second end of the test specimen. Conductivity of the coating is measured at a plurality of different measurement points at different distances along the bend axis within the bend area. The measured conductivity values are correlated to the distances along the bend axis to determine an elongation limit of the coating.

Other aspects of the invention will become apparent by consideration of the detailed description and accompanying drawings.

### BRIEF DESCRIPTION OF THE DRAWINGS

FIG. 1 illustrates a group of coated panels.

FIG. 2 illustrates a conical mandrel bender.

FIG. 3 illustrates insertion of one of the coated panels into the conical mandrel bender of FIG. 2.

FIG. 4 is a rear view of the coated panel in the conical mandrel bender.

FIG. 5 illustrates the bending of the coated panel into a test specimen including a conical portion.

FIG. 6 is a front view of the conically-bent test specimen of FIGS. 3-5.

FIG. 7 illustrates a first, small-radius end of the test specimen of FIG. 6.

FIG. 8 illustrates a second, large-radius end of the test specimen of FIG. 6.

FIG. 9 illustrates the group of test specimens created from the coated panels of FIG. 1 in preparation for a testing method according to one aspect of the invention.

FIG. 10 illustrates marking length intervals on one of the test specimens of FIG. 9.

FIG. 11 is a perspective view of a grounding jig coupled to one of the test specimens.

FIG. 12 illustrates a conductivity tester with probe.

FIG. 13 illustrates the conductivity testing of one of the test specimens with the conductivity tester of FIG. 12.

FIG. 14 illustrates one of the test specimens marked with conductivity measurements.

FIG. 15 illustrates another one of the test specimens marked with conductivity measurements.

FIG. 16 illustrates yet another one of the test specimens marked with conductivity measurements.

FIG. 17 is a graph illustrating conductivity versus distance, including plots for each of five test specimens of FIG. 9.

FIG. 18 is a graph illustrating conductivity versus distance, including only the maximum and minimum conductivity measurement taken at each distance among the five plots of FIG. 17.

FIG. 19 illustrates an exemplary brake booster having a coating with an anti-corrosion rating based on a method according to aspects of the invention.

FIG. 20 illustrates an alternate brake booster having a coating with an anti-corrosion rating based on a method according to aspects of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

As described in further detail below, a method is provided for testing elasticity or cracking resistance of coatings on substrates of sheet metal or other bendable, conductive materials. The method provides quantitative measurements of the elasticity. The method can be used to determine the corrosion resistance of components with coatings, for example epoxy-type coatings applied with organic solvents in a paint-cationic e-coat process. Conductivity measurements are taken along an increasing radius bend of a coated test specimen as a means for evaluating elasticity or crack resistance, and thus corrosion resistance. The use of conductivity measurements allows more accurate quantification of an existence and severity of cracking in the coating due to elongation of the coating caused by, for example, bending of the coated test specimen. The conductivity measurements can be used to determine a predictable numerically-based corrosion resistance of the test specimen and components manufactured with the coating. The conductivity measurements can be used to set engineering development and validation specifications, as well as production quality specifications for ensuring that corrosion standards are met.

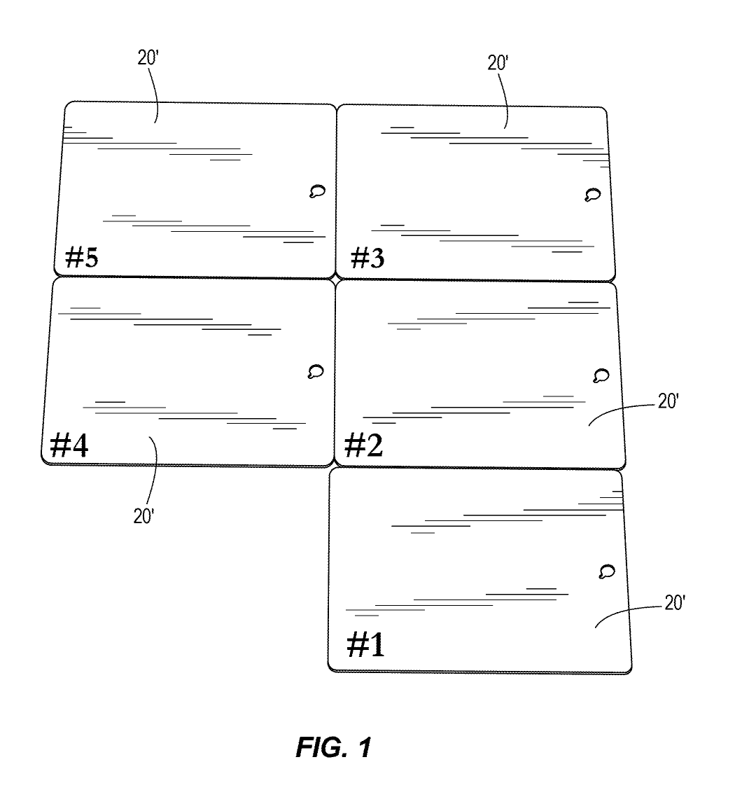

The test specimen(s) can be a standard test panel, a simulated component, a prototype or production component. For example, the test specimen can be a test panel 20 (FIG. 1) similar to that specified by ASTM D522, a simulated brake booster shell component prepared for a so-called “Shell Bending Test,” or a production brake booster component.

Although certain steps may be added, deleted or modified within certain aspects of the invention, an exemplary test method includes each of the following steps:
1. Prepare one or more test specimens (e.g., a test panel prepared according to ASTM D522 by preparing a coated panel and bending the coated panel using a conical mandrel bender);
2. Mark measurement points on the test specimen in an area of interest (e.g., marking measurement points at regular intervals, for example every 5.0 mm)—the area of interest can be an apex of a bend in the test specimen, and the measurement points can extend along the apex;
3. Attach a conductivity probe to the test specimen;
4. Obtain a conductivity value as a quantitative value of conductivity at each of the measurement points;
5. Record the conductivity values;
6. Compare the conductivity values in a series;
7. Optionally obtain a new or additional conductivity value for any conductivity value in the series that appears to be anomalous or otherwise uncertain;
8. Determine a final conductivity value of the panel coating at each of the measurement points (e.g., selecting one of a plurality of measured values, taking a mean, median, or mode of a plurality of measured values, etc.);
9. Analyze the series of conductivity values versus position or distance along the test specimen; and
10. Determine at what distance along the panel a maximum acceptable conductivity value is observed.

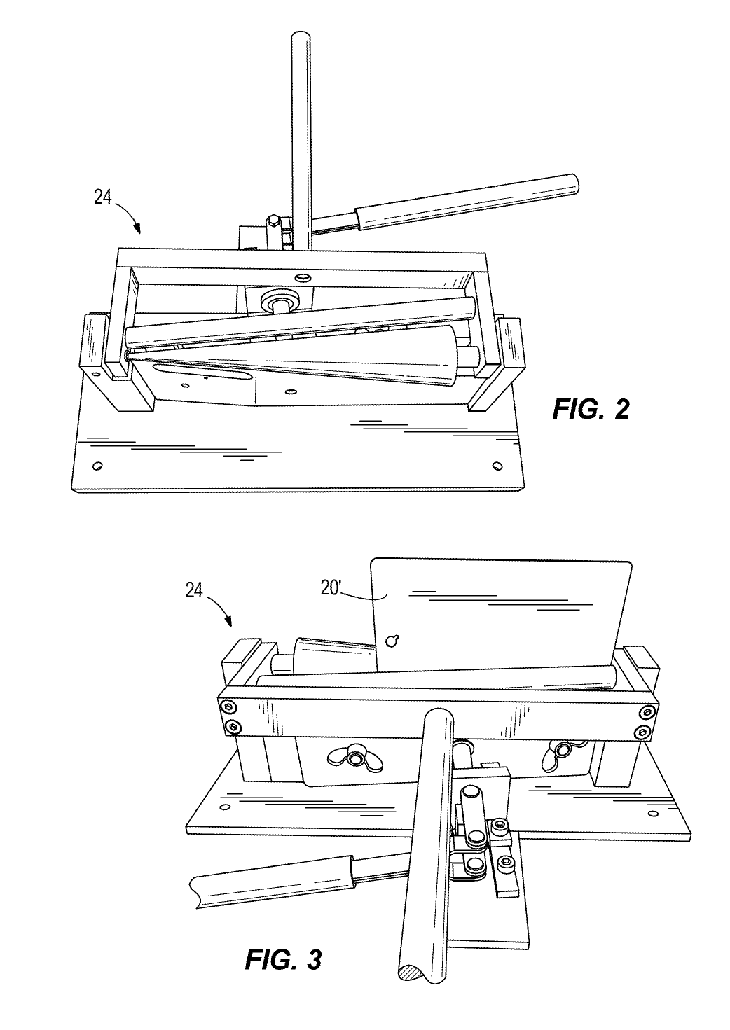

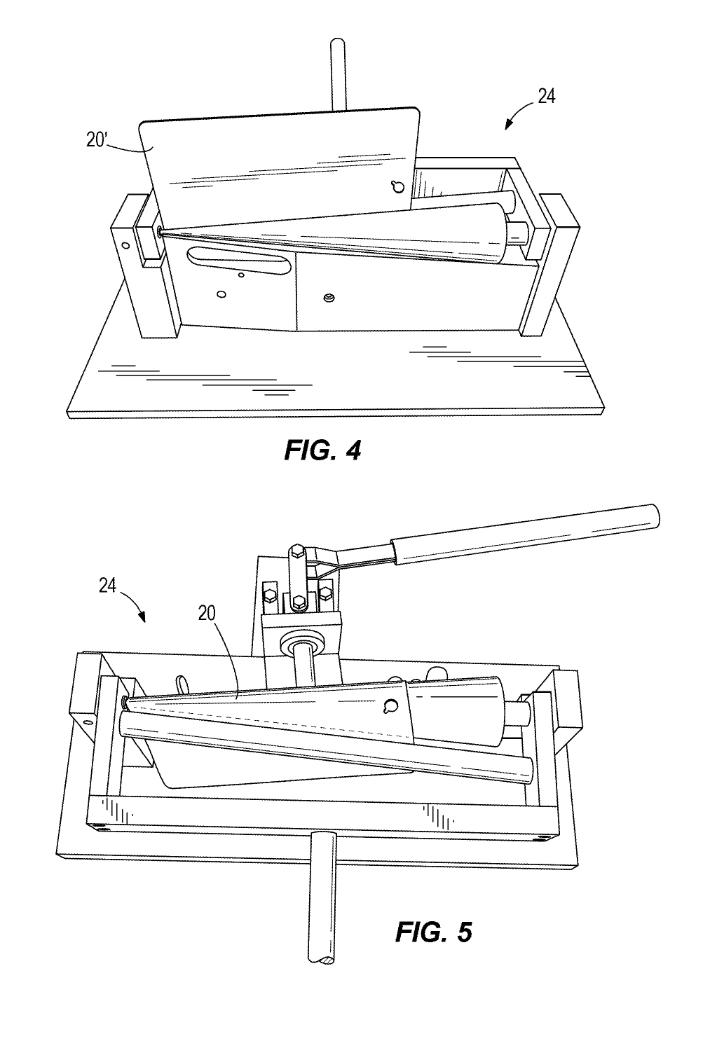

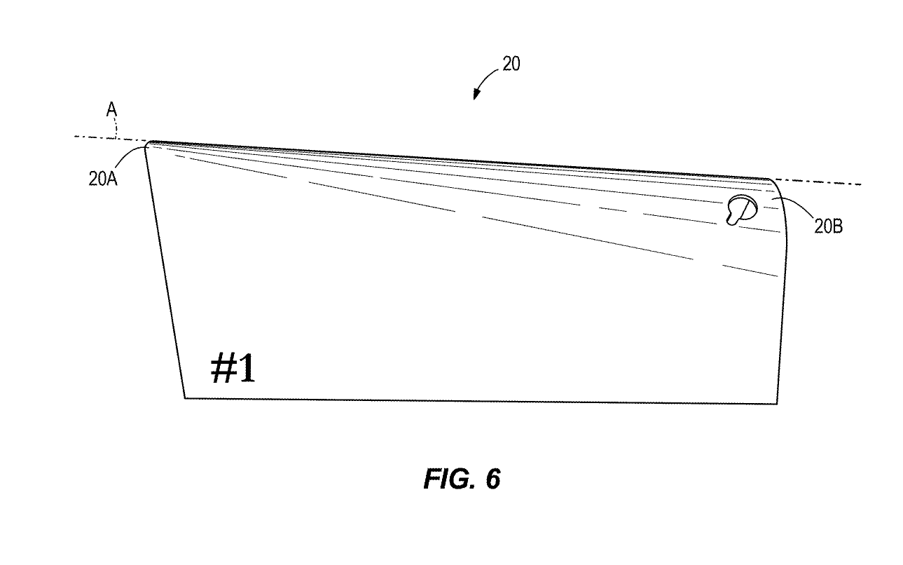

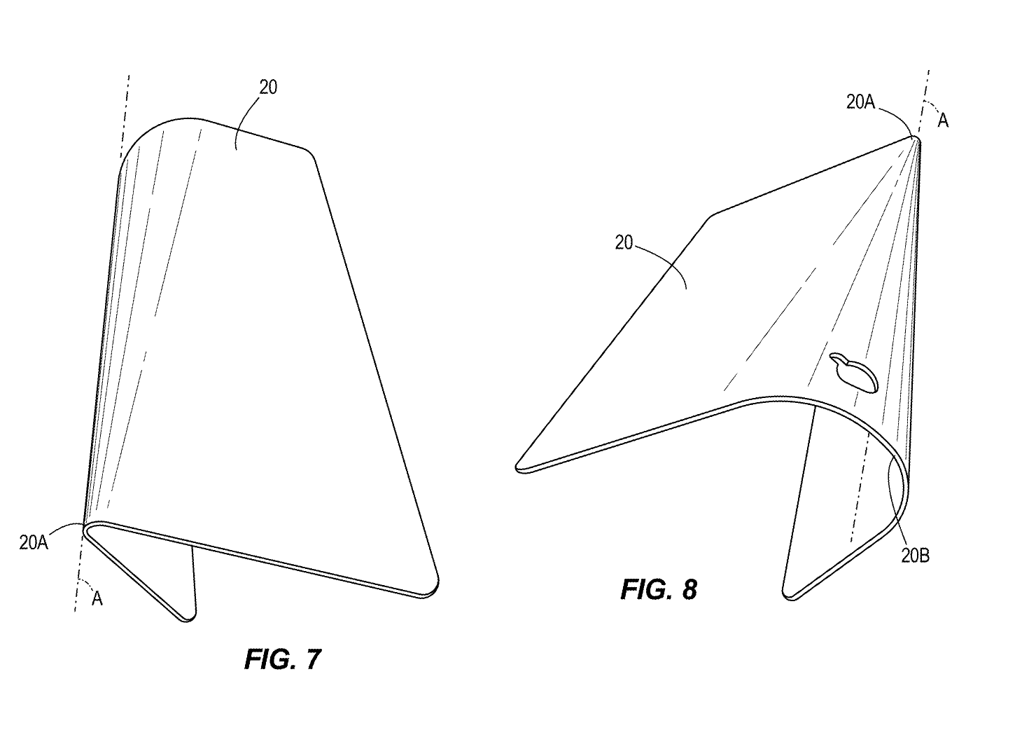

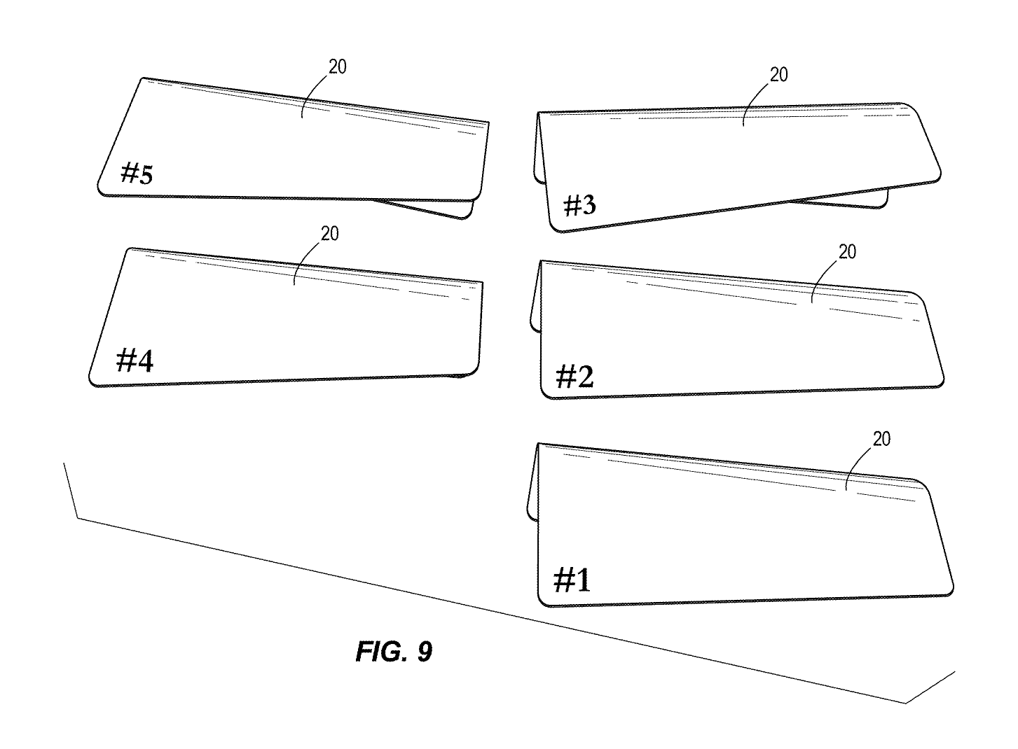

FIGS. 1-9 illustrate the preparation of a plurality of test specimens 20 in accordance with step #1 above. FIG. 1 illustrates five flat sheet metal panels 20′, each coated or painted with a substantially identical coating film to be evaluated for predicting corrosion resistance (i.e., elasticity or crack resistance) via conductivity measurement. Although each individual panel 20′ and its coating may have minor variations due to normal tolerances, all are prepared of substantially identical materials and with substantially identical processes. A conical mandrel bender 24 with jig is shown in FIG. 2, and the bending of the first specimen 20 from the flat sheet metal panel 20′ is shown in FIGS. 3-5. The first bent specimen 20 is shown in detail in FIGS. 6-8, and FIG. 9 illustrates a group of similarly-prepared specimens 20. All the coated specimens 20 are bent to the same shape, having a small radius end 20A (FIGS. 6 and 7) and a large radius end 20B (FIGS. 6 and 8).

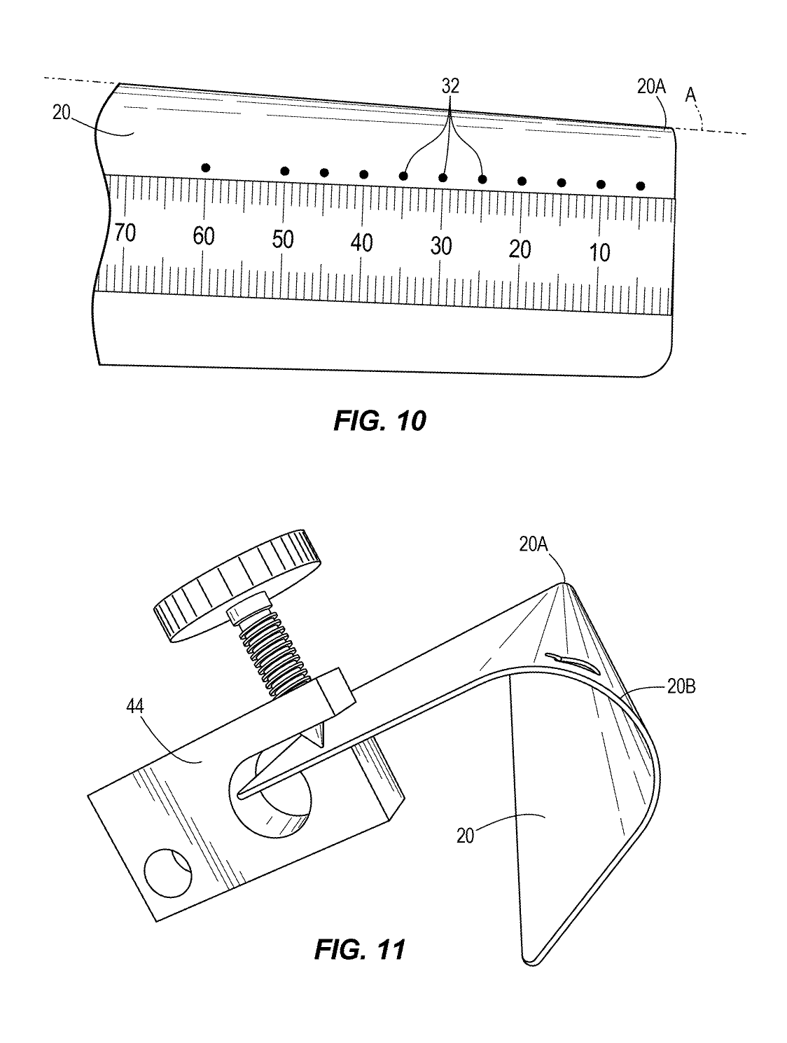

FIG. 10 illustrates the marking of measurement points 32 on one of the test specimens 20 in accordance with step #2 above. The measurement points 32 are marked at regular intervals of 5.0 mm, although other regular and irregular intervals may be marked as measurement points 32 in some constructions. The markings for the measurement points 32 are made adjacent an apex A of the bend in the test specimen 20, and the series of measurement points 32 extends along the apex A. The measurement points 32 may be provided at other locations, offset from the apex A, but still within the bend area (i.e., not within one of the unbent portions that remain flat after bending). Each one of the group of test specimens 20 is marked with measurement points in a similar manner.

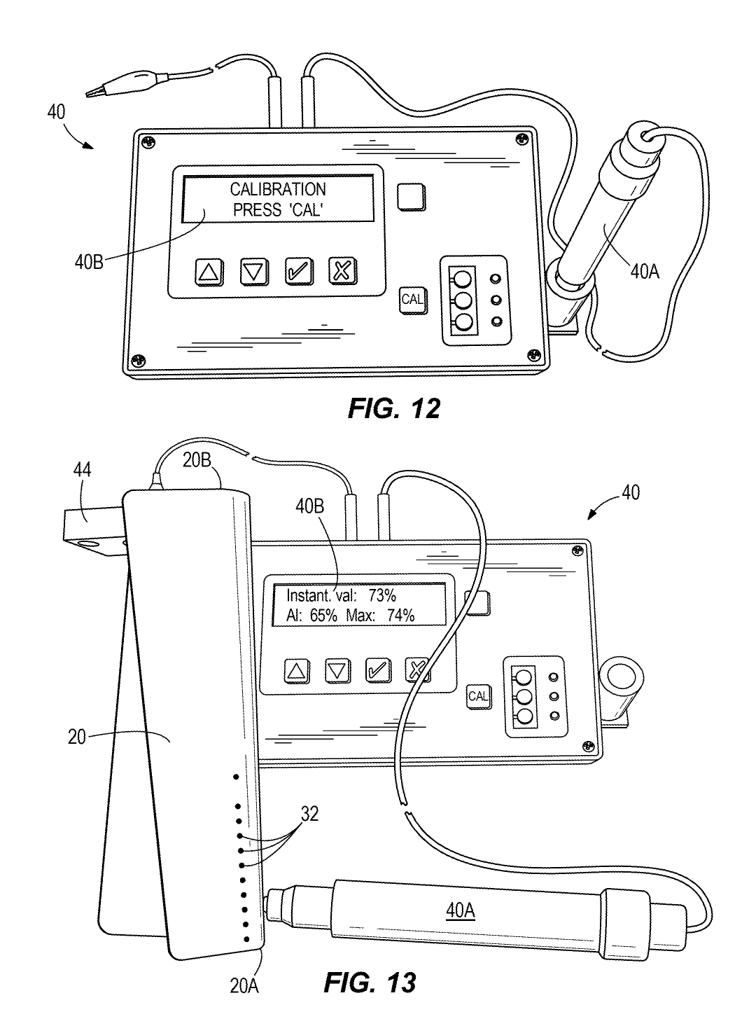

In accordance with step #3 above, a measurement probe 40A of a conductivity tester 40 is coupled to a test specimen 20 for obtaining electrical conductivity measurements (step #4). A grounding jig 44 (FIG. 11) is provided for continuity throughout testing of various specimens 20. FIG. 11 illustrates the grounding jig 44 coupled to one of the specimens 20. The conductivity tester 40 is provided with the measurement probe 40A and a display 40B as illustrated in FIG. 12. The conductivity tester 40 can be calibrated for a particular combination of conductive substrate and applied coating so that the conductivity tester 40 reads 0 for the coating in the original condition (on the flat panel 20′) prior to bending and reads 100 for the uncoated substrate (e.g., bare sheet metal), which may correspond with a completely degraded coating not capable of providing any electrical resistance beyond that present in the substrate material. FIG. 13 illustrates taking a conductivity measurement in accordance with step #4 above by placing the probe 40A on the specimen 20 at the apex A of the bend and reading the display 40B of the conductivity tester 40. The measurements are taken at each marked measurement point 32 from the small diameter end 20A. A tip of the probe 40A may be wetted with alcohol and may be pressed through the coating at each measurement point 32 for a predetermined amount of time to take the corresponding conductivity measurement.

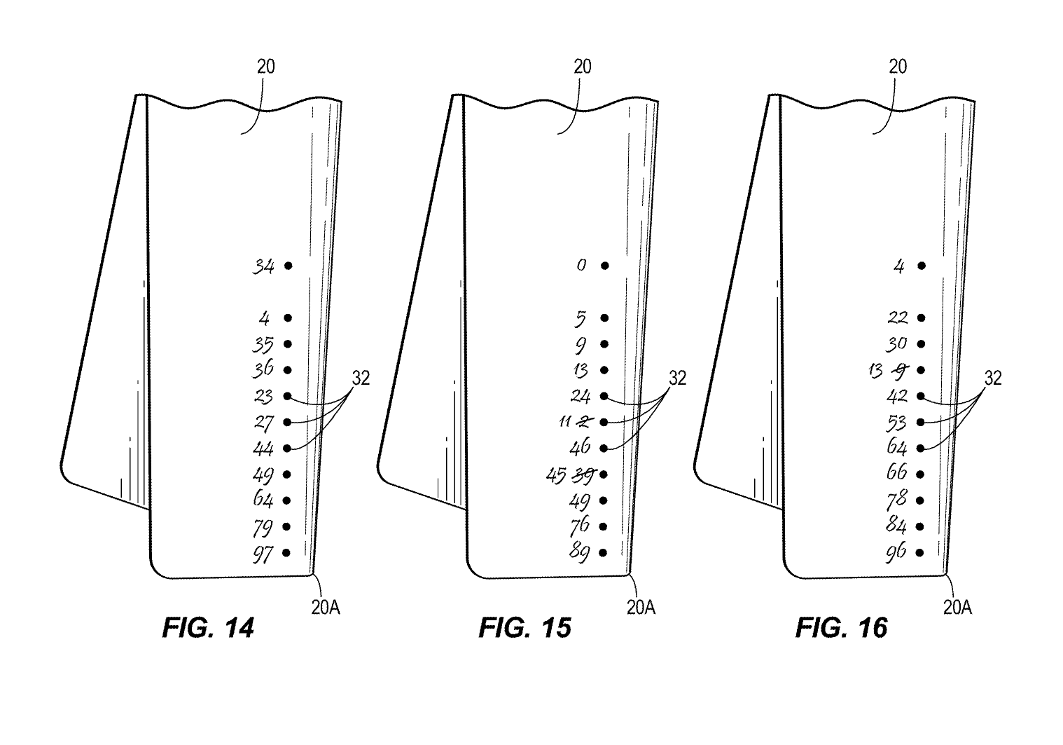

As set forth in steps #5-6 above, the measured conductivity values are recorded for series comparison. As shown in FIG. 14, the conductivity values can be recorded directly on the test specimen 20, next to the marked measurement points 32, if desired. As shown in FIGS. 15 and 16, multiple measurements can be taken and recorded at one or more of the marked locations (e.g., if there is any uncertainty regarding the value of the initial measurement), in accordance with step #7 above. Also, as expected, conductivity measurements will vary among the test specimens 20 even though they are prepared as identically as possible. Thus, while the entire method can be carried out with a single test specimen 20, testing a group of specimens may be preferred for statistical reasons.

The conductivity measurements can be used to determine elongation limits of the coating and/or bending limits of a production component (by design) for ensuring a desired corrosion resistance. The conductivity measurements can also be used to establish quality limits for quality testing of production components. Table 1 below shows exemplary conductivity measurements collected from one sample, “Sample A” of the five bent test specimens 20. One or more conductivity measurement is taken on each of the test specimens 20 at each of the measurement points 32, which are provided every 5.0 mm from 5.0 mm to 50 mm, and an additional marking at 60 mm. The values recorded in Table 1 are the particular conductivity measurements determined for each measurement point 32 of each test specimen 20. For example, step #8 can include selecting one of a plurality of measured values, or taking a mean, median, or mode of a plurality of repeated measurements at a particular measurement point 32 on one test specimen 20. In a scenario where a single trusted conductivity measurement is taken at a measurement point 32, the final conductivity value is determined to be that measurement as of steps #4-5, without the need for data manipulation or selection from a plurality of measurements. Step #8 may also refer to determining a final conductivity value from conductivity measurements of multiple measured test specimens 20. In other words, after measuring multiple test specimens 20 having the same applied coating, the data sets are evaluated to determine a final representative conductivity value for each common measurement point 32 among the group of specimens 20.

Minimum and maximum conductivity measurements for each measurement point 32 among the five test specimens 20 are also noted at the last two columns of Table 1. A film thickness (FT) measurement (e.g., a single measurement for each test specimen 20) is recorded in Table 1. The film thickness is measured to ensure general consistency so as to identify where poor crack resistance may be attributable to film thickness rather than the elasticity of the coating material. In an exemplary construction, this may simply be confirmed to be within a predetermined range, such as 20 μm+/−5 μm, for example.

TABLE 1

| | Sample Group A | | | | | | |
|---|---|---|---|---|---|---|---|
| | 1 | 2 | 3 | 4 | 5 | Min | Max |
| P # | | | | | | | |
| FT (μm) | 23.4 | 23.1 | 23.2 | 24.0 | 23.5 | 23.1 | 24.0 |
| Dist. (mm) | | | | | | | |
| 5 | 92 | 97 | 89 | 100 | 96 | 89 | 100 |
| 10 | 80 | 79 | 76 | 89 | 84 | 76 | 89 |
| 15 | 72 | 64 | 49 | 59 | 78 | 49 | 78 |
| 20 | 71 | 49 | 45 | 54 | 66 | 45 | 71 |
| 25 | 67 | 44 | 46 | 44 | 64 | 44 | 67 |
| 30 | 22 | 27 | 11 | 28 | 53 | 11 | 53 |
| 35 | 11 | 23 | 24 | 23 | 42 | 11 | 42 |
| 40 | 20 | 36 | 13 | 15 | 13 | 13 | 36 |
| 45 | 26 | 35 | 9 | 20 | 30 | 9 | 35 |
| 50 | 8 | 4 | 5 | 2 | 22 | 2 | 22 |
| 60 | 8 | 34 | 0 | 6 | 4 | 0 | 34 |

As can be seen from the exemplary data of Table 1, conductivity decreases with an increase in distance (from the small diameter end 20A toward the large diameter end 20B). This is expected as bending to a smaller radius incurs higher strain or elongation (length change per unit original length) that corresponds to higher stress to the coating than a larger, flatter radius. Higher stress results in a higher likelihood of cracking

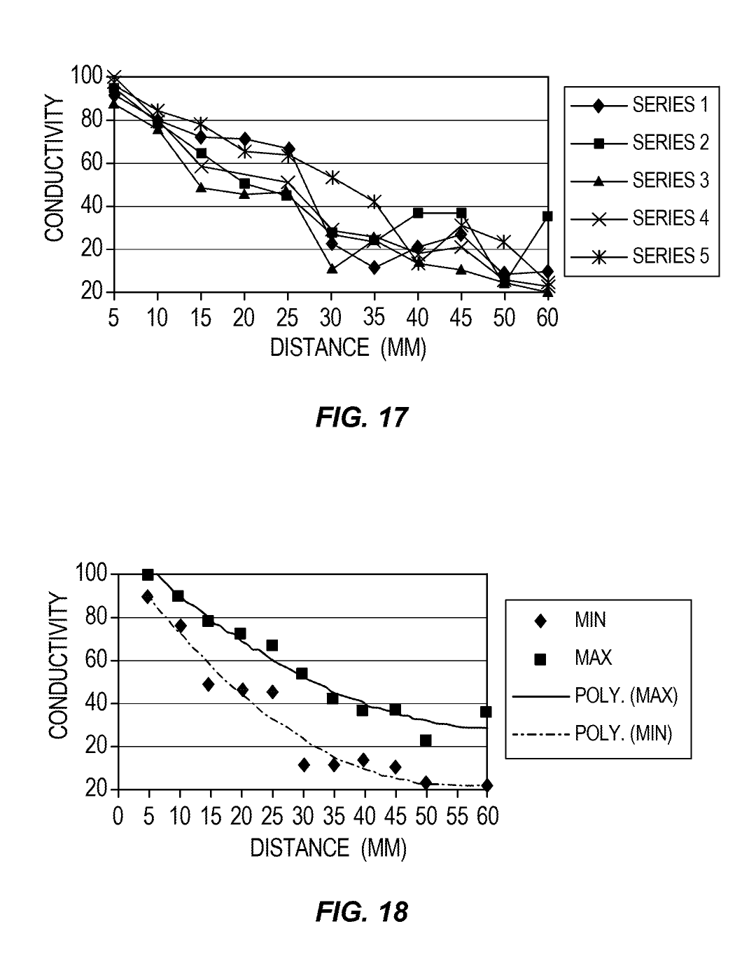

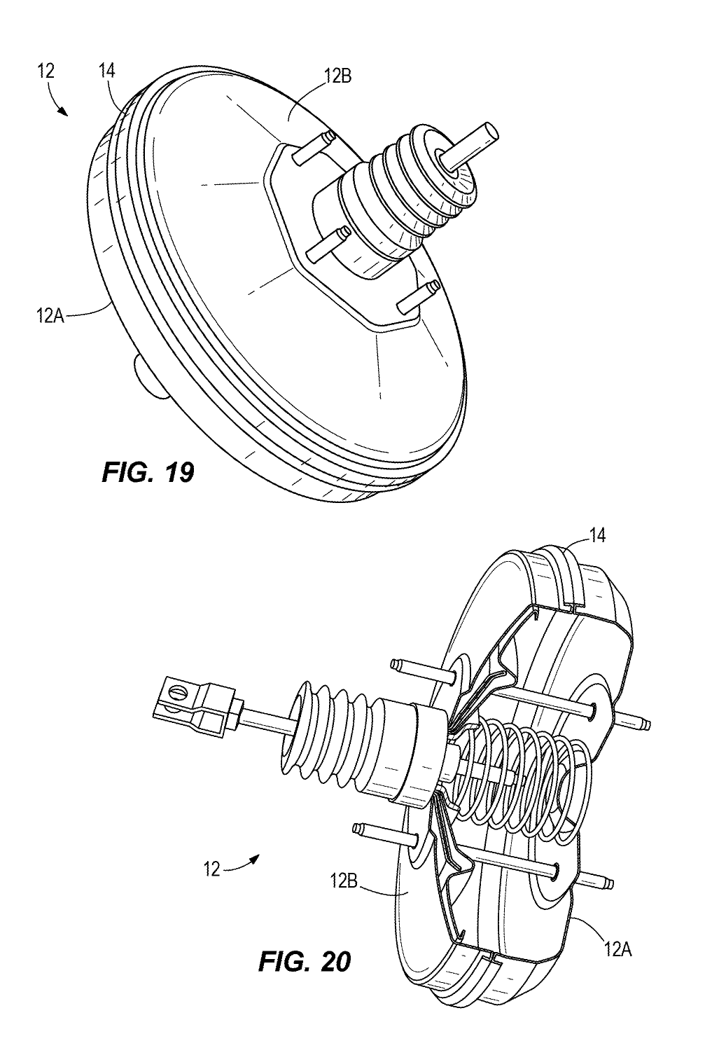

FIG. 17 illustrates a graph with plots of conductivity versus position for all five measurement series corresponding to Table 1. FIG. 18 illustrates a graph with plots of conductivity versus position for only the maximum and minimum values from all five measurement series corresponding to Table 1 (i.e., final two columns). Polynomial trend lines are also plotted for each of the minimum series and the maximum series in the graph of FIG. 18.

According to step #9, the series of conductivity values is analyzed against the corresponding position or distance along the test specimen 20. In doing so, the series of conductivity values may be analyzed to determine (according to step #10) at what distance along the test specimen 20 a maximum acceptable conductivity value is observed. When a trend line is plotted, this can be a particular distance between two measurement points 32, where an exact conductivity measurement was not taken. In one non-limiting example, the maximum acceptable conductivity value may be 60. This value can be determined to correspond to the maximum amount of acceptable micro-cracking that preserves acceptable corrosion resistance of the coating. Once the distance value corresponding to the conductivity value of 60 is identified, the result can be compared against a predetermined specification distance to determine whether or not the coating conforms to the specification. In one non-limiting example, the specification can be 32 mm. Thus, where the test data indicates that the conductivity value of 60 occurs within 32 m of the small diameter end 20A, the coating conforms to the specification. On the other hand, if the conductivity value of 60 does not occur until the distance exceeds 32 mm (the higher distance indicating less bending), the coating does not conform to the specification. The conductivity value and distance specification corresponds to identifying an elongation limit of the coating, without the need for measuring actual engineering elongation. In other words, the process identifies how much strain or elongation the coating can withstand while maintaining satisfactory integrity (i.e., while not exceeding a particular conductivity value).

Of course, other manners of utilizing the data (e.g., utilizing the plots of minimum and/or maximum conductivity, FIG. 18) to determine specifications and conformance to the specifications are optional. Regardless of the particular values or data evaluation preferred, real measurements and numerical data analysis can be used to evaluate coating elasticity and corresponding anti-corrosion performance, eliminating the time and expense of actual corrosion tests and the subjective ratings associated with the results of such tests.

It should be noted that the exact listing of steps may be modified within the confines of the invention, whereby one or more steps may be combined, replaced, or eliminated. Furthermore, although the invention has been shown to be useful for epoxy e-coat, the invention may be applied to any one of a variety of coatings applied to a variety of conductive substrates, such that the invention shall not be limited to a particular e-coat chemistry or methodology. Although this process has been found to be useful in ensuring a high reliability in anti-corrosion properties of the coatings for brake booster shells (e.g., where a knurling process for shell joining necessarily deforms the coating), the invention may not be limited to such applications or processes.

What is claimed is:

1. A test method for evaluating elasticity of a coating, the method comprising:
applying a coating onto a conductive substrate to form a test specimen;
bending the test specimen into a shape having a bend axis and a bend area having a radius of curvature that increases along the bend axis from a first end to a second end of the test specimen;
measuring conductivity of the coating at a plurality of different measurement points at different distances along the bend axis within the bend area; and
correlating the measured conductivity values to the distances along the bend axis to determine an elongation limit of the coating.

2. The test method of claim 1, wherein correlating includes identifying a distance from the first end along the bend axis where a predetermined maximum allowable conductivity value occurs.

3. The test method of claim 2, further comprising approving the coating for corrosion resistance when the predetermined maximum allowable conductivity value occurs within a predetermined distance from the first end.

4. The test method of claim 2, further comprising disapproving the coating for corrosion resistance when the predetermined maximum allowable conductivity value occurs at a distance from the first end that is greater than a predetermined distance.

5. The test method of claim 2, wherein the distance where the predetermined maximum allowable conductivity value occurs is determined from a trend line fit to the series of conductivity measurements.

6. The test method of claim 1, wherein measuring conductivity includes measuring conductivity with a precision conductivity tester calibrated to read 0 for a completely in-tact coating and to read 100 for the uncoated conductive substrate.

7. The test method of claim 6, wherein a conductivity measurement of 60 is identified as the maximum allowable value for a conductivity measurement taken at a predetermined distance from the first end.

8. The test method of claim 7, wherein the predetermined distance is 32 millimeters.

9. The test method of claim 1, wherein the test specimen is a brake booster shell.

10. The test method of claim 1, further comprising marking the test specimen with distance intervals to indicate the location of each conductivity measurement.

11. The test method of claim 10, wherein the test specimen is marked and conductivity measurements are taken at even intervals.

12. The test method of claim 11, wherein the intervals are 5.0 millimeter intervals.

13. A test method wherein a plurality of substantially identical test specimens are produced and measured according to the coating applying, bending, and conductivity measuring steps of claim 1, and wherein the correlating step is carried out once for all of the test specimens, with one final conductivity value being determined for each common measurement point among all of the plurality of test specimens.

14. The test method of claim 13, wherein the final conductivity value at each common measurement point is determined as the maximum measured conductivity among the plurality of test specimens.

15. The test method of claim 13, wherein the final conductivity value at each common measurement point is determined as the mean of the conductivity measurements among the plurality of test specimens.

16. The test method of claim 13, wherein the final conductivity value at each common measurement point is determined as the median of the conductivity measurements among the plurality of test specimens.

17. The test method of claim 13, wherein the final conductivity value at each common measurement point is determined from trend lines fit to the conductivity measurements of each individual one of the plurality of test specimens.
